(19) United States
(12) Patent Application Publication
(10) Pub. No.: US 2009/0094953 A1
(43) Pub. Date: Apr. 16, 2009

(54) COMPACT FILTER ELEMENT AND METHOD FOR SEALING AN END THEREOF

(75) Inventor: Charles Vaillant, Kalamazoo, MI (US)

Correspondence Address: Mann+Hummel GMBH, Dept: VR-P Plant 5.4, Hindenburgstr. 45, Ludwigsburg, 71638, DE

(73) Assignee: MANN+HUMMEL GMBH, Ludwigsburg (DE)

(21) Appl. No.: 12/248,056

(22) Filed: Oct. 9, 2008

Related U.S. Application Data
(60) Provisional application No. 60/978,993, filed on Oct. 10, 2007.

(51) Int. Cl. B01D 46/00; B32B 37/00

(52) U.S. Cl. 55/520; 156/184

(57) ABSTRACT

A compact filter element and a method for sealing an end thereof are provided. The compact filter element includes a filter material formed into a winding and an adhesive element, having a predetermined size and shape, that fixes an outer end portion of the filter material to an outer side portion of the filter material. The adhesive element provides improved control of the amount of adhesive applied to the filter element, because the adhesive element has a predetermined amount of adhesive. Thus, the costs associated with the adhesive process can be reduced, by minimizing excessive use of adhesive. Also, the process of applying the adhesive element is a faster process and requires less expensive equipment to implement than a hot melt process.

### BACKGROUND OF THE INVENTION

The present invention relates to a filter element including at least one flat element wound into a compact body through which fluid to be filtered flows axially between its two axial end faces, the end of the flat element being fixed to the outer side of the compact body by an adhesive element. The present invention also relates to a method for sealing an outer end of a compact filter element with the adhesive element.

Compact air filter elements are known in the prior art. These filter elements are formed of a corrugated or pleated filter paper and a smooth filter paper. The filter papers are bonded together and then tightly wound together to form a filter element of the desired size. A first band of adhesive is applied to one margin of the smooth filter paper, and a second band of adhesive is applied to another margin of the smooth paper filter on the opposite side at the opposite end of the filter paper. Thus, when the corrugated and smooth filter papers are wound together and the adhesive bands solidify, intervening spaces between the corrugated and the smooth layer are alternately closed at the two end faces to prevent direct flow through the channels formed between the filter papers. A fluid stream, particularly air taken in by an internal combustion engine and flowing from the unfiltered air side to the filtered air side flows initially only into a dead-end channel, then through the filter paper and out of an oppositely oriented dead-end channel on the other side. Compared to conventional pleated filters, these compact air filters have the advantage of offering either a larger filter surface for the same overall size or the same filter surface in a smaller overall size.

After the winding of the filter element, the end of the paper needs to be hermetically sealed. The sealing of the end of the paper prevents unwinding of the compact filter element and seals the filter element to prevent unfiltered air from entering the filter element from the side thereof. Known compact filter elements use an adhesive hot melt, i.e., an adhesive that acts as a liquid when sufficiently heated, but becomes a solid when cooled, to seal and fasten the end of the filter element.

The process variability of the hot melt operation, however, creates a significant variation in the amount of hot melt disposed on the filter element. The difficulty in controlling the hot melt process creates quality problems in the seal provided by the hot melt adhesive. Also, the cycle time of the hot melt operation is a limiting factor in a filter element production line.

FIG. 1 illustrates a conventional compact filter element 100 having a strip or mass of hot melt adhesive 110 at an outer side thereof. The end 101 of the filter material 102 forming the compact filter element 100 is fixed to the compact filter with the hot melt adhesive 110. As shown in FIG. 1, the mass of hot melt adhesive 110 has an irregular shape due to the variability of the hot melt process. By having an irregular shape and thickness, the hot melt adhesive 110 can use an excessive amount of adhesive, thereby wasting the adhesive resources during the production process of the filter element 100. As shown in FIG. 1, the holt melt adhesive process can also leave portions of the end 101 of the filter material 102 unsealed (lower portion of end 101), thereby reducing the effectiveness of the hot melt adhesive 110.

### SUMMARY OF THE INVENTION

It is an object of the present invention to provide an improved compact filter element. It is another object of the present invention to provide a method for applying the adhesive element to the compact filter element.

These and other objects and advantages are achieved in accordance with the present invention by providing a compact filter element with an adhesive element having a predetermined size and shape, such as an adhesive tape, and a method for sealing the same. The adhesive element according to the present invention provides better control of the amount of adhesive applied to the filter, because the adhesive element has a predetermined amount of adhesive. Thus, the costs associated with the adhesive process can be reduced, by minimizing excessive use of adhesive. Also, the process of applying the adhesive element according to the present invention is a faster process and requires less expensive equipment to implement than the hot melt process. Additionally, the quality and consistency of the compact filter element and the seal at the end of the paper thereof are significantly improved.

Other objects, advantages and novel features of the present invention will become apparent from the following detailed description of the invention when considered in conjunction with the accompanying drawings.

### BRIEF DESCRIPTION OF THE DRAWINGS

The invention will be described in further detail hereinafter with reference to illustrative preferred embodiments shown in the accompanying drawing figures, in which:

FIG. 1 illustrates a filter element having a strip or mass of hot melt adhesive at an outer side thereof, in accordance with the prior art;

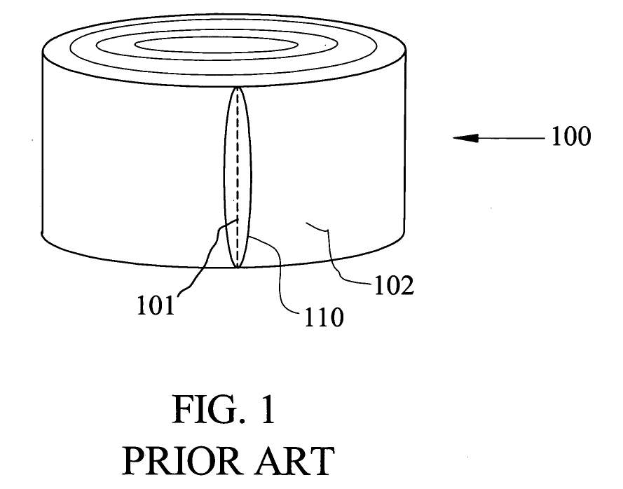

FIG. 2 illustrates an illustrative embodiment of a filter element with an adhesive element, in accordance with the present invention; and

FIG. 3 illustrates an illustrative embodiment of a method for sealing a compact filter element, in accordance with the present invention.

### DETAILED DESCRIPTION OF ILLUSTRATIVE EMBODIMENTS

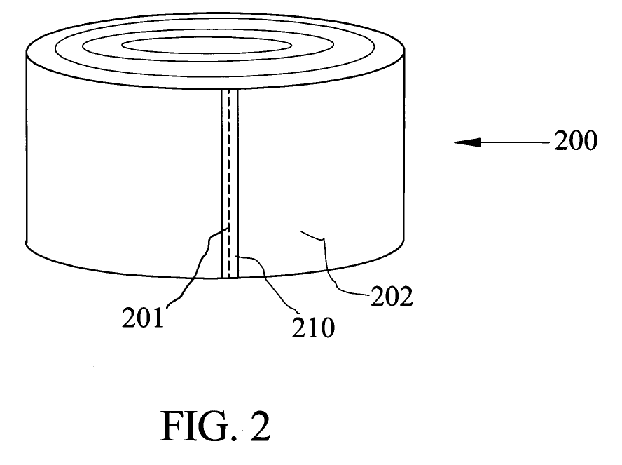

FIG. 2 illustrates an illustrative embodiment of a filter element with an adhesive element, in accordance with the present invention. The filter element 200 is formed from filter material 202, which may be a corrugated or pleated filter paper and a smooth filter paper. The filter papers are bonded together and then tightly wound together to form a filter element 200 of the desired size. Bonding is effected by applying bands of adhesive in the margin such that intervening spaces between the corrugated and the smooth layer are alternately closed at the two end faces to prevent direct flow through the channels formed between the filter papers.

An adhesive element 210 is attached at the outer end 201 of the filter material 202, thereby fixing the position of the end 201. The adhesive element 210 may be attached to the filter material 202 by an adhesive element applying device or by hand. The adhesive element 210 fastens the end 201 of the filter material 202 to the outside of the filter element 200, thereby preventing the filter material 202 from unwinding. Additionally, the adhesive element 210 seals the end 201 of the filter material 202 to prevent unfiltered air from entering the filter element from the side thereof

The adhesive element 210, unlike an adhesive hot melt, has a solid structure before, during and after installation thereof. According to illustrative embodiments of the present invention, the adhesive element 210 has a predetermined size, shape and thickness. The size and (rectangular) shape of the adhesive element 210 illustrated in FIG. 2 is merely illustrative, as other sizes and shapes may be used. Because the size, shape and thickness of the adhesive element 210 are predetermined, the amount of adhesive is also predetermined. By using an adhesive element according to the present invention, the amount of adhesive applied to the filter element can be controlled precisely. Accordingly, the amount of adhesive used for each filter element produced on a production line may be tightly controlled, thereby limiting the amount of wasted adhesive. Furthermore, the quality and consistency of the filter elements are improved.

According to an illustrative embodiment of the present invention, the adhesive element 210 may be an adhesive tape having a predetermined size and shape. The adhesive tape has a solid part with an adhesive backing to attach the outer end of the wound filter material to the filter element. The adhesive tape may be any type of adhesive tape having appropriate characteristics for sealing and fixing the end of the filter material to the outside of the filter element.

According to an illustrative embodiment of the present invention, the adhesive element may include information such as part numbers, company names, mounting instruction and/or company trade name for advertising, etc. This information may be printed on the outer side of the adhesive element, for example, where it can be viewed by a user.

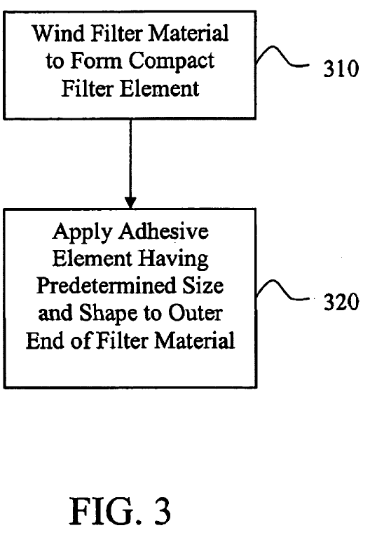

FIG. 3 illustrates an illustrative embodiment of a method for sealing a compact filter element, in accordance with the present invention. In step 310, the filter material 202 is wound into a desired shape to form a compact filter element 200. The filter material 202 may be wound around a solid structure having any desired shape. Once the winding process is complete, an adhesive element 210 having a predetermined size and shape may be applied to the outer end portion of the filter material in step 320. The adhesive element 210 provides a seal for the end of the filter material 202 and prevents the filter material 202 from unwinding. The size and shape of the adhesive element 210 may be selected as desired by a user. In a preferred embodiment of the present invention, the adhesive element 210 has a length equal to the length of the filter element 200.

The adhesive element according to the present invention is easier to apply than a hot melt adhesive, which involves a complicated and expensive process. Moreover, the equipment used to apply the adhesive element is less expensive than the equipment used to apply the hot melt adhesive. Accordingly, the present invention provides a savings in capital equipment cost and production cycle time, as well as a labor cost advantage. Further cost reduction could be expected due to the saving of maintenance cost or downtime because of faulting equipment. Additionally, the present invention provides a cost reduction due to reduction of the quantity of adhesive applied and more consistent dispensing of the adhesive.

The foregoing description and examples have been set forth merely to illustrate the invention and are not intended to be limiting. Since modifications of the disclosed embodiments incorporating the spirit and substance of the invention may occur to persons skilled in the art, the invention should be construed broadly to include all variations within the scope of the appended claims and equivalents thereof.

What is claimed is:

1. A compact filter element comprising:
a filter material including alternate flat and corrugated sheets formed into a winding having axial channels; and
an adhesive element, having a predetermined size and shape, that fixes an outer end portion of the filter material to an outer side portion of the filter material.

2. The compact filter element of claim 1, wherein the adhesive element comprises an adhesive tape.

3. The compact filter element of claim 1, wherein the adhesive element includes at least one of a part number, a company name, mounting instruction and company trade name for advertising.

4. A method for sealing a compact filter element, comprising:
winding a filter material to form the compact filter element; and
applying an adhesive element having a predetermined size and shape to an end portion of the filter material, thereby fixing the end portion of the filter material to an outer side portion of the filter material and sealing the end portion of the filter material.
